(19) United States
(12) Patent Application Publication
(10) Pub. No.: US 2019/0245924 A1
(43) Pub. Date: Aug. 8, 2019

(54) THREE-STAGE COST-EFFICIENT DISAGGREGATION FOR HIGH-PERFORMANCE COMPUTATION, HIGH-CAPACITY STORAGE WITH ONLINE EXPANSION FLEXIBILITY

(71) Applicant: Alibaba Group Holding Limited, Grand Cayman (KY)

(72) Inventor: Shu LI, Santa Clara, CA (US)

(21) Appl. No.: 15/889,583

(22) Filed: Feb. 6, 2018

(51) Int. Cl. H04L 29/08; H04L 12/851; H04L 12/26

(52) U.S. Cl. CPC H04L 67/1097; H04L 49/25; H04L 43/0894; H04L 47/2425

(57) ABSTRACT

Systems and methods for disaggregating network storage from computing elements are disclosed. In one embodiment, a system is disclosed comprising a plurality of compute nodes configured to receive requests for processing by one or more processing units of the compute nodes; a plurality of storage heads connected to the compute nodes via a compute fabric, the storage heads configured to manage access to non-volatile data stored by the system; and a plurality of storage devices connected to the storage heads via a storage fabric, each of storage devices configured to access data stored on a plurality of devices in response to requests issued by the storage heads.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever

### BACKGROUND

### Technical Field

The disclosed embodiments are directed to the field of network computing systems and, in particular, to highly distributed and disaggregated network computing systems.

### Description of the Related Art

With the widespread adoption of computer networks, server-based systems were developed to provide remote computation and storage functionality to client devices. Originally, these systems took the form of server devices generally comprising the same components (e.g., CPU, storage, etc.) and functionality (e.g., computing, storage, etc.) as client-side devices.

As the amount of network data and traffic increased, some approaches correspondingly increased the processing power and storage of a server device. Alternatively, or in conjunction with the foregoing, some approaches added more server devices to handle increased loads. As these “vertically” scaled systems faced challenges with ever-increasing traffic, some systems were designed to “decouple” computing power from storage power. These decoupled systems were created based on the observation that computing demands and storage demands are not equal. For example, a device with a CPU and storage medium may spend a fraction of its time utilizing the CPU and the majority of time accessing a storage medium. Conversely, for high-computational processes, the server may spend most time using the CPU and little to no time accessing a storage device. Thus, the compute and storage processing are not in lockstep with one another.

One attempt to address this observation is to separate the compute components of a server and the storage components. The decoupled systems then couple the compute and storage components via a computer network. In this way, storage devices can operate independently from compute components and each set of components can be optimized as needed. Further, computing capacity and storage capacity can be independently scaled up and down depending on the demands on a system.

Current network requirements have begun to place strains on this decoupled architecture. Specifically, the more data stored by a decoupled system, the more capacity required. Thus, in current systems, storage devices must be upgraded during usage, and an upgrade cycle for a storage device cannot be synchronized with the upgrade cycle of its CPU and memory components. Thus, the CPU and memory are upgraded together with drive unnecessarily with high frequency. This significantly increases the costs on procurement, migration, maintenance, deployment, etc. On the other hand, if a server is equipped with high-capacity storage devices at the beginning, this increases the CPU and memory requirements of the device. Considering the capacity of single drive rapidly goes up in the latest generations, the total storage capacity in one storage node is huge, which means a considerable amount of upfront expense.

Another problem with current systems is bandwidth consumed by network traffic. In current systems, there exist both the traffic from compute node to storage node and the traffic among the storage nodes. Generally, the I/O requests from the compute node should be guaranteed to be accomplished within the terms of a certain service-level agreement (SLA). However, when the workload is high, a race for network bandwidth occurs, and the traffic from compute node may not be assured with sufficient network bandwidth.

### BRIEF SUMMARY

To remedy these deficiencies in current systems, systems and methods for disaggregating network storage from computing elements are disclosed. The disclosed embodiments describe a three-stage disaggregated network whereby a plurality of drive-less compute nodes and a plurality of drive-less storage heads (i.e., computing devices with no solid-state drive storage) are connected via a compute fabric. The storage heads manage data access by the compute nodes as well as manage managerial operations needed by a storage cluster. The storage cluster comprises a plurality of NVMeOF storage devices connected to the storage heads via storage fabric. Compute nodes and storage head devices do not include any solid-state drive devices and storage an operating system on a NAND Flash device embedded within a network interface card, thus minimizing the size of these devices. Since the network is highly disaggregated, there exist multiple traffic routes between the three classes of devices. These traffic routes may be prioritized and re-prioritized based on network congestion and bandwidth constraints. To prioritize the traffic routes, a method is disclosed which prioritizes the individual traffic routes to ensure that computationally intensive traffic is given priority over storage device management traffic and other non-critical traffic.

In one embodiment, a system is disclosed comprising a plurality of compute nodes configured to receive requests for processing by one or more processing units of the compute nodes; a plurality of storage heads connected to the compute nodes via a compute fabric, the storage heads configured to manage access to non-volatile data stored by the system; and a plurality of storage devices connected to the storage heads via a storage fabric, each of storage devices configured to access data stored on a plurality of devices in response to requests issued by the storage heads.

In another embodiment, a device comprises a plurality of processing units; and a network interface card (NIC) communicatively coupled to the processing units, the NIC comprising a NAND Flash device, the NAND Flash device storing an operating system executed by the processing units.

In another embodiment, a method comprises assigning, by a network switch, a minimal bandwidth allowance for each of a plurality of traffic routes in a disaggregated network, the disaggregated network comprising a plurality of compute nodes, storage heads, and storage devices; weighting, by the network switch, each traffic route based on a traffic route priority; monitoring, by the network switch, a current bandwidth utilized by the disaggregated network; distributing, by the network switch, future packets according to the weighting if the current bandwidth is indicative of a low or average workload; and guaranteeing, by the network switch, minimal bandwidth for a subset of the traffic routes if the current bandwidth is indicative of a high workload, the subset of traffic routes selected based on the origin or destination of the route comprising a compute node.

### BRIEF DESCRIPTION OF THE FIGURES

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram illustrating a conventional distributed computing system according to some embodiments.

FIG. 2A is a block diagram of a conventional compute node according to some embodiments of the disclosure.

FIG. 2B is a block diagram of a conventional storage node according to some embodiments of the disclosure.

FIG. 3 is a block diagram illustrating a three-stage disaggregation network architecture according to some embodiments of the disclosure.

FIG. 4 is a block diagram of a compute node or a storage head device according to some embodiments of the disclosure.

FIG. 5 is a block diagram of an NVMeOF storage device according to some embodiments of the disclosure.

FIG. 6 is a traffic diagram illustrating traffic routes through a three-stage disaggregation network architecture according to some embodiments of the disclosure.

FIG. 7 is a flow diagram illustrating a method for ensuring quality of service in a three-stage disaggregation network architecture according to some embodiments of the disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

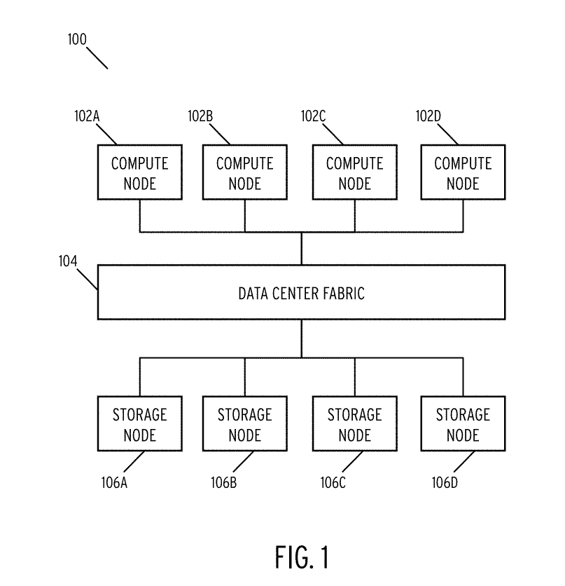

FIG. 1 is a block diagram illustrating a conventional distributed computing system according to some embodiments.

In one embodiment, the system (100) comprises a data center or other network-based computing system. In some embodiments, the system (100) is deployed as a private data center while in other embodiments the system (100) may be deployed as a public data center. In some embodiments, the system (100) provides infrastructure-as-a-service (IaaS) functionality.

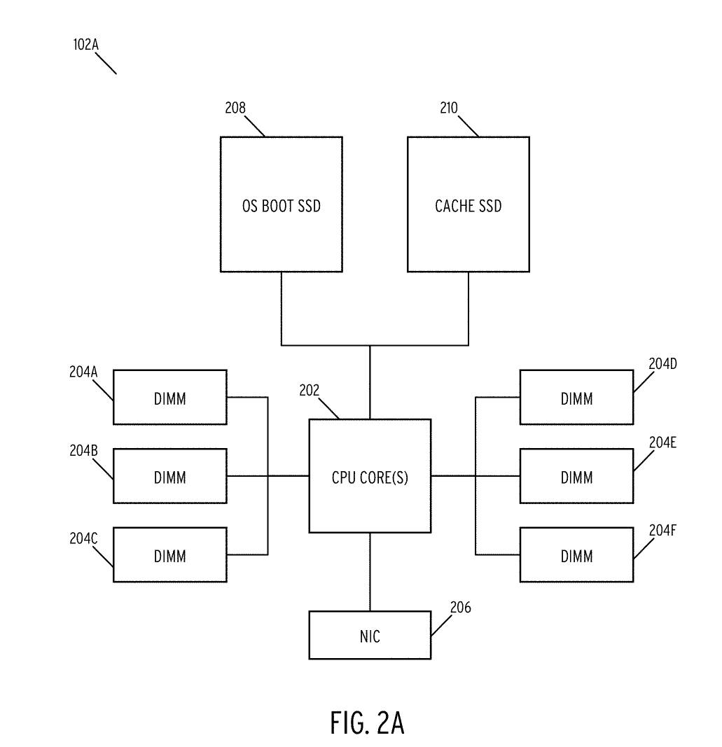

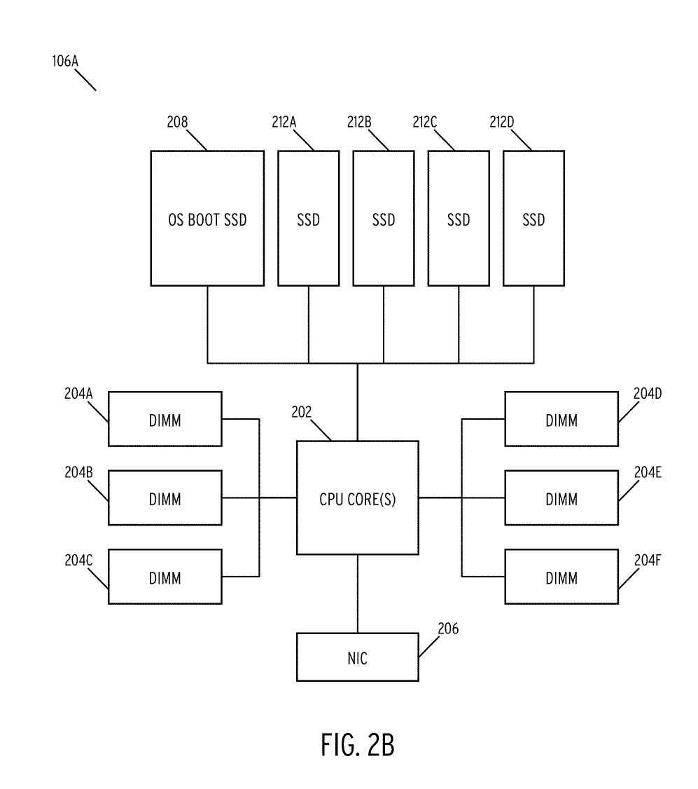

The system (100) includes a plurality of compute nodes (102A-102D). In one embodiment, a given compute node performs various processing tasks. For example, each compute node may be equipped with a network interface to receive requests from third parties or from other systems. Each compute node includes one or more processors (e.g., CPUs, GPUs, FPGAs, artificial intelligence chips, ASIC chips) and memory. Each compute node performs tasks according to software or other instructions stored on, or otherwise accessible by, the compute node. In some embodiments, a compute node comprises a physical computing device while in other embodiments the compute nodes comprise virtual machines. In general, compute nodes (102A-102D) perform CPU or GPU-based computations. However, as will be discussed, compute nodes (102A-102D) do not include long-term or non-volatile storage and thus must store any permanent data elsewhere. The internal structure of a compute node (102A-102D) is described more fully in the description of FIG. 2A, the disclosure of which is incorporated herein by reference in its entirety.

Each compute node (102A-102D) is connected to a plurality of storage nodes (106A-106D) via data center fabric (104). Data center fabric (104) comprises a physical and/or logical communications medium. For example, data center fabric (104) can comprise an Ethernet or InfiniBand connective fabric allowing for bi-directional data communications. In some embodiments, data center fabric (104) includes one or more network devices such as switches, servers, routers, and other devices to facilitate data communications between network devices deployed in the system (100).

The system (100) additionally includes a plurality of storage nodes (106A-106D). In one embodiment, a storage node (106A-106D) comprises a server device including one or more non-volatile storage device such as hard-disk drives (HDDs) or solid-state drives (SSDs). Alternatively, or in conjunction with the foregoing, storage nodes (106A-106D) may comprise virtual machines or virtual logical unit numbers (LUNs). In some embodiments, a collection of storage nodes (106A-106D) comprise a storage area network (SAN) or virtual SAN. The internal structure of a storage node (106A-106D) is described more fully in the description of FIG. 2B, the disclosure of which is incorporated herein by reference in its entirety.

Since each compute node (102A-102D) does not include non-volatile storage, any storage needs of the processing tasks on the compute nodes must be transferred (via fabric (104)) to the storage nodes (106A-106D) for permanent or otherwise non-volatile storage. To facilitate this transfer, all drives in the storage nodes (106A-106D) are visualized as a single logical storage device that is accessible by the compute nodes (102A-102D). In some embodiments, data stored by storage nodes (106A-106D) is also replicated to ensure the data consistency, high availability, and system reliability.

The separation of compute and storage nodes illustrated in the system (100) provides a rudimentary separation of computing devices. However, this separation of compute and storage is incomplete. Modern systems are becoming more and more powerful and complicated, including incremental features such as snapshots, erasure coding, global deduplication, compression, global cache, and other. These features increase the demand on the computation power utilized by the compute nodes (102A-102D) to support the system (100) itself. In other words, the requirement on computation capacity inside the storage nodes is strong and the processors of storage nodes must be sufficiently powerful.

FIG. 2A is a block diagram of a conventional compute node according to some embodiments of the disclosure.

The compute node (102A) includes one or more CPU cores (202). In one embodiment, CPU cores (202) may be implemented as a commercial off-the-shelf multi-core microprocessor, system-on-a-chip, or other processing device. The number of cores in CPU cores (202) may be one, or more than one and the disclosure places no limitation on the number of cores. The compute node (102A) additionally includes multiple dual in-line memory module (DIMM) slots (204A-204F). DIMM slots (204A-204F) comprise slots for volatile memory storage locations to store applications and the results of processing by CPU cores (202) as known in the art. Compute node (102A) additionally includes a network interface (206) that may comprise an Ethernet, InfiniBand, or other network interface. NIC (206) receives requests for processing as well as data from a data center fabric and, by proxy, from external users.

The compute node (102A) includes two SSD devices: OS boot SSD (208) and cache SSD (210). In one embodiment, OS boot SSD (208) stores an operating system such as a Linux-based on Windows-based operating system. In some embodiments, OS boot SSD (208) may comprise a physical device or may comprise a partition of a larger SSD. In general, OS boot SSD (208) is sized exclusively to store an operating system.

Additionally, the compute node (102A) includes a cache SSD (210). In one embodiment, the cache SSD (210) comprises a standalone SSD. Alternatively, the cache SSD (210) may comprise a partition on a physical SSD. In general, cache SSD (210) is designed to store the data processed by CPU cores (202). In this embodiment, cache SSD (210) may be utilized to store data that does not fit entirely within the memory space provided by DIMMs (204A-204F). In some embodiments, the cache SSD (210) is configured with a preset capacity to ensure that a targeted cache hit rate is met. As compared to the cache SSD (210), the OS boot SSD (208) may have a substantially smaller capacity than the cache SSD (210).

In some embodiments, the CPU cores (202) may be significantly greater than, for example, the number of cores in the storage node depicted in FIG. 2B. In some embodiments, the number of cores is larger due to the computationally intensive tasks performed by the compute node (102A). In some embodiments, CPU cores (202) may additionally be clocked at a higher frequency than the cores in a storage node in order to increase the throughput of the compute node (102A).

FIG. 2B is a block diagram of a conventional storage node according to some embodiments of the disclosure.

Storage node (106A) includes CPU cores (202), DIMM slots (204A-204F), a NIC (206), and an OS boot SSD (208). These components may be identical to those described in the description of FIG. 2A, the disclosure of which is incorporated herein by reference in its entirety. In some embodiments, the OS boot SSD (208) in FIG. 2B may store a vendor-specific operating system for managing SSDs. (212A-212D).

Storage node (106A) differs from compute node (102A) in that the storage node (106A) does not include a cache SSD (e.g., 210). Storage node (106A) does not utilize a cache SSD due to the lack of computational intensity demands placed on the CPU cores (202) in FIG. 2B. In contrast to FIG. 2A, storage node (106A) include multiple SSD devices (212A-212D). SSD devices (212A-212D) may comprise high-capacity SSD drives for longer-term data storage. In the illustrated embodiment, SSD devices (212A-212D) may be significantly larger than either OS boot SSD (208) or cache SSD (210).

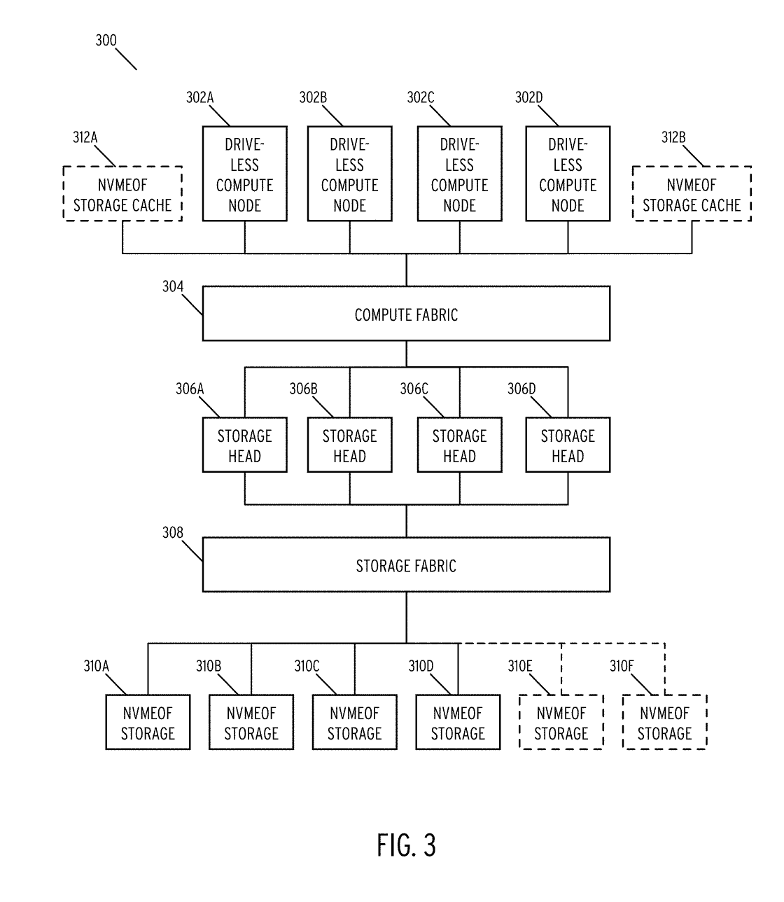

FIG. 3 is a block diagram illustrating a three-stage disaggregation network architecture according to some embodiments of the disclosure.

The architecture illustrated in FIG. 3 includes drive-less compute nodes (302A-302D), a compute fabric (304), storage heads (306A-306D), storage fabric (308), and NVMeOF (Non-Volatile Memory express-over-Fabric) storage devices (310A-310F). NVMoF storage is a simplified instrument that converts data encoded using the Non-Volatile Memory express (NVMe) protocol for storage to the high-speed fabric (e.g., Ethernet, InfiniBand).”

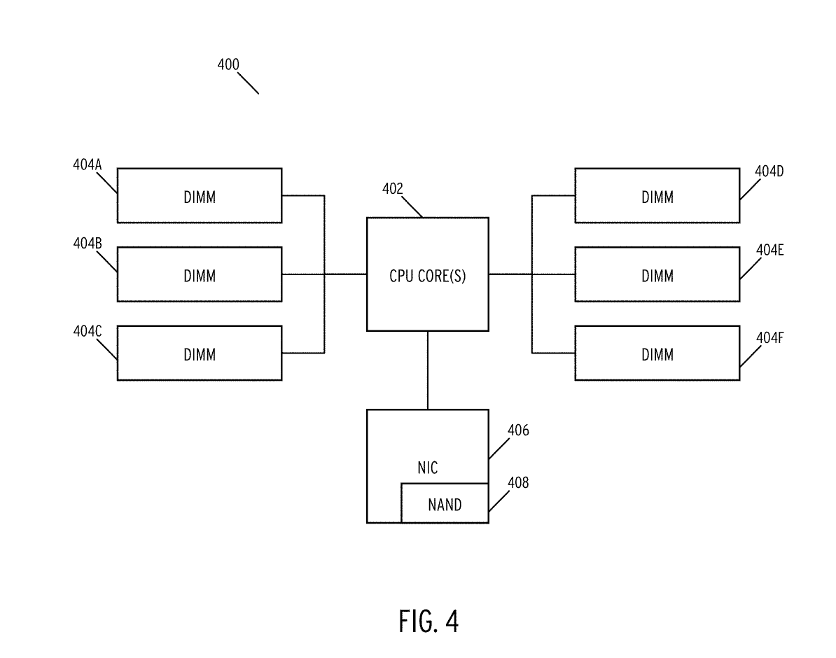

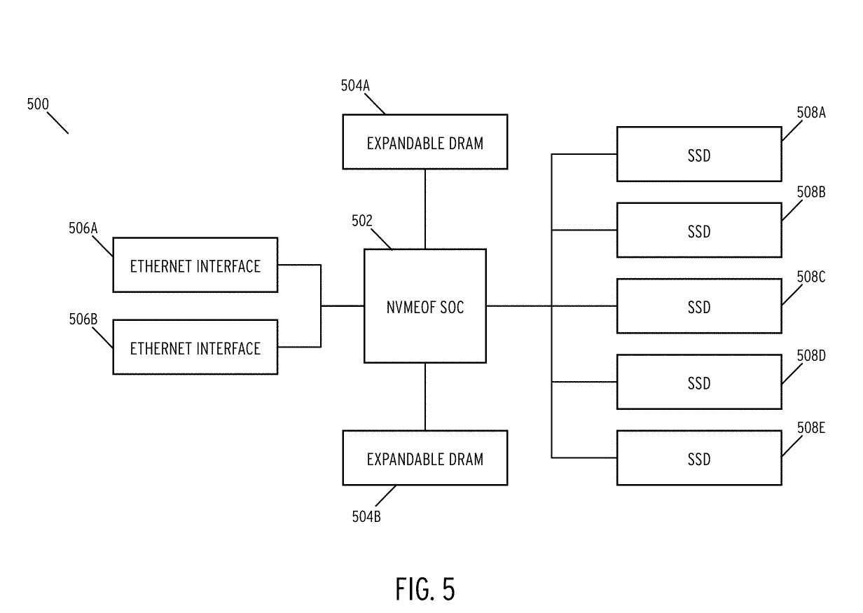

In the illustrated system (300), drive-less compute nodes (302A-302B), storage heads (306A-306D), and NVMeOF storage devices (310A-310F) may each be assigned a unique Internet Protocol (IP) address within the system (300). The internal architecture of the drive-less compute nodes (302A-302D) and the storage heads (306A-306D) are described more fully in the description of FIG. 4A, incorporated herein by reference in its entirety. The internal architecture of the NVMeOF storage devices (310A-310F) is described more fully in the description of FIG. 5, incorporated herein by reference in its entirety.

Since each device is assigned an independent IP address, compute traffic and storage traffic are separated and each device handles either compute or storage traffic, with no intertwining of traffic. Thus, compute traffic and storage traffic can be distinguished and separated per the origin and the destination.

In the illustrated architecture, drive-less compute nodes (302A-302D) receive incoming network requests (e.g., requests for computations and other CPU-intensive tasks) from external devices (not illustrated). In the illustrated embodiment, drive-less compute nodes (302A-302D) may perform many of the same tasks as the compute nodes discussed in FIG. 1.

When a given compute node (302A-302D) is required to store data non-volatilely, the compute node (302A-302D) transmits the data to NVMeOF storage devices (310A-310F) via compute fabric (304), storage heads (306A-306D), and storage fabric (308). Compute fabric (304) and storage fabric (308) may comprise an Ethernet, InfiniBand, or similar fabric. In some embodiments, compute fabric (304) and storage fabric (308) may comprise the same physical fabric and/or the same network protocols. In other embodiments, compute fabric (304) and storage fabric (308) may comprise separate fabric types. In some embodiments, compute fabric (304) and storage fabric (308) may comprise a single physical fabric and may only be separated logically.

As illustrated, data from drive-less compute nodes (302A-302D) are managed by an intermediary layer of storage heads (306A-306D). In the illustrated embodiment, storage heads (306A-306D) manage all access to NVMeOF storage devices (310A-310F). That is, storage heads (306A-306D) control data transfers from drive-less compute nodes (302A-302D) to NVMeOF storage devices (310A-310F) and vice-versa. Storage heads (306A-306D) may additional implement higher-level interfaces for performing maintenance operations on NVMeOF storage devices (310A-310F). Details of the operations managed by storage heads (306A-306D) are described in more detail herein, the description of such operations incorporated herein by reference in their entirety.

As described above, the computational loads placed on network storage systems continues to increase and is a non-trivial load. Thus, in order to manage the operations of the NVMeOF storage devices (310A-310F), the system (300) includes storage heads (306A-306D). In one embodiment, the storage heads (306A-306D) may be structurally similar to drive-less compute nodes (302A-302D). Specifically, each storage heads (306A-306D) may comprise a processing device with multiple cores, optionally clocked at a high frequency. Additionally, storage heads (306A-306D) do not include significant non-volatile storage. That is, the storage heads (306A-306D) substantially do not include any SSDs.

Storage heads (306A-306D) receive data from drive-less compute nodes (302A-302D) for long-term storage at NVMeOF storage devices (310A-310F). After receiving data from drive-less compute nodes (302A-302D), storage heads (306A-306D) coordinate write operations to NVMeOF storage devices (310A-310F). Additionally, storage heads (306A-306D) coordinate read accesses to NVMeOF storage devices (310A-310F) in response to requests from drive-less compute nodes (302A-302D). Additionally, storage heads (306A-306D) manage requests from NVMeOF storage devices (310A-310F). For example, storage heads (306A-306D) receive management requests from NVMeOF storage devices (310A-310F) and handle maintenance operations of the NVMeOF storage devices (310A-310F) as discussed in more detail below.

As described above, storage fabric (308) comprises a high-speed data fabric for providing a single interface to the various NVMeOF storage devices (310A-310F). The storage fabric (308) may comprise an Ethernet, InfiniBand, or other high-speed data fabric. In some embodiments, storage fabric (308) may form a wide area network (WAN) allowing for storage heads (306A-306D) to be geographically separate from NVMeOF storage devices (310A-310F). Additionally, compute fabric (304) may form a WAN allowing for a full geographic separation of drive-less compute nodes (302A-30D), storage heads (306A-D), and NVMeOF storage devices (310A-310F).

The system (300) includes multiple NVMeOF storage devices (310A-310F). In the illustrated embodiment, some NVMeOF storage devices (310E-310F) may be optional. In general, the number of NVMeOF storage devices (310A-310F) may be increased or decreased independently of any other devices due to the use of storage fabric (308) which provides a single interface view of the cluster of NVMeOF storage devices (310A-310F). In one embodiment, communications between storage heads (306A-306D) and NVMeOF storage devices (310A-310F) via storage fabric (308) utilize an NVM Express (NVMe) protocol or similar data protocol. NVMeOF storage devices (310A-310F) may additionally communicate with other NVMeOF storage devices (310A-310F) without the need for communicating with storage heads (306A-306D). These communications may comprise direct copy, update, synchronization through the RDMA (remote direct memory access) operations.

In one embodiment, NVMeOF storage devices (310A-310F) primarily convert NVMe packets received from storage heads (306A-306D) to PCIe packets. In some embodiments, NVMeOF storage devices (310A-310F) comprise simplified computing devices that primarily provide SSD storage and utilize lower capacity processing elements (e.g., processing devices with fewer cores and/or a lower clock frequency).

In alternative embodiments, the system (300) additionally includes NVMeOF storage caches (312A, 312B). In one embodiment, the NVMeOF storage caches (312A, 312B) may comprise computing devices such as that illustrated in FIG. 5. In one embodiment, NVMeOF storage caches (312A, 312B) operate as non-volatile cache SSDs similar to the cache SSD discussed in the description of FIG. 2A. In contrast to FIG. 2A, the cache provided by NVMeOF storage caches (312A, 312B) are removed from the internal architecture of the drive-less compute nodes (302A-302D) and connected to the drive-less compute nodes (302A-302D) via compute fabric (304). In this manner, the drive-less compute nodes (302A-302D) share the cache provided by NVMeOF storage caches (312A, 312B) rather than maintain their own cache SSD. This disaggregation allows the cache provided by NVMeOF storage caches (312A, 312B) to be increased separately from upgrades to the drive-less compute nodes (302A-302D). That is, if some or all of drive-less compute nodes (302A-302D) require additional cache, the NVMeOF storage caches (312A, 312B) may be upgraded or expanded while the drive-less compute nodes (302A-302D) are still online.

The NVMeOF storage caches (312A, 312B) are used primarily for cache purposes and do not require the high availability that is enforced by multiple copies or erasure coding, etc. Thus, per the relaxed requirements, the data in the NVMeOF storage caches (312A, 312B) can be dropped if needed. The capacity utilization efficiency of NVMeOF storage caches (312A, 312B) is improved by defragmentation as compared to cache SSDs installed in individual compute nodes. That is, if an individual NVMeOF storage cache (312A, 312B) capacity was not used evenly, some NVMeOF storage caches (312A, 312B) may become full or worn-out earlier than other NVMeOF storage caches (312A, 312B). Although described in the context of NVMeOF devices, any suitable network storage device may be utilized in place of a specific NVMeOF protocol-adhering device.

Notably, using the architecture depicted in FIG. 3 results in numerous advantages over conventional systems such as those similar to the one depicted in FIG. 1. Specifically, since the SSD components of the system are fully removed from other computing components, these SSD components may be placed together, densely in a data center. Thus, data transfers between SSDs, and across devices, are improved given the shorter distance traveled by data. As an example, replication of a given SSD to an SSD in a disparate device must only travel a short distance as all SSDs are geographically situated closer than the system in FIG. 1. Second, the compute nodes and storage heads may be reconfigured as, for example, server blades. In particular, a given server blade can contain significantly more compute nodes or storage heads as no SSD storage is required at all in each device. This compression caused by the disaggregation results in less rack space needed to support the same number of compute nodes as conventional systems.

FIG. 4 is a block diagram of a drive-less compute node or a drive-less storage head device according to some embodiments of the disclosure. The drive-less device (400) illustrated in FIG. 4 may be utilized as either a compute node or a storage head, as discussed in the description of FIG. 3.

Drive-less device (400) includes a plurality of CPU cores (402). In one embodiment, CPU cores (402) may be implemented as a commercial off-the-shelf multi-core microprocessor, system-on-a-chip, or other processing device. The number of cores in CPU cores (402) may be one, or more than one and the disclosure places no limitation on the number of cores. The drive-less device (400) additionally includes multiple DIMM slots (404A-404F). DIMM slots (404A-404F) comprise slots for volatile memory storage locations to store applications and the results of processing by CPU cores (402) as known in the art.

As in FIG. 2A, drive-less device (400) includes a network interface (406) that may comprise an Ethernet, InfiniBand, or other network interface card. NIC (406) receives requests for processing as well as data from a data center fabric and, by proxy, from external users. However, NIC (406) additionally includes a NAND Flash (408) chip. In some embodiments, other types of Flash memory may be used.

NAND Flash (408) stores an operating system and any additional software to be executed by the CPU cores (402). That is, NAND Flash (408) comprises the only non-volatile storage of device (400). In one embodiment, NIC (406) comprises a networking card installed within the drive-less device (400) (e.g., as a component of a blade server). In this embodiment, the NIC (406) is modified to include the NAND Flash (408) directly on the NIC (406) board.

As described above, existing systems require the use of an SSD for an operating system and an SSD for cache purposes. By utilizing the NVMeOF storage caches depicted in FIG. 3, the system removes the first of two SSDs from the compute node. The NAND Flash (408) integrated on the NIC (406) itself allows for the second, and only remaining, SSD to be removed from the compute node. Thus, the compute node (or storage head) is a “drive-less” computing device occupying less space than a traditional compute node. The result is that more compute nodes or storage heads can be fit within the same form factor rack that existing systems utilize, resulting in increased processing power and lower total cost of ownership of the system.

FIG. 5 is a block diagram of an NVMeOF storage device according to some embodiments of the disclosure. The NVMeOF storage device (500) depicted in FIG. 5 may comprise the NVMeOF storage devices discussed in the description of FIG. 3.

NVMeOF storage device (500) includes a processing element such as an NVMeOF system-on-a-chip (SoC) (502). In some embodiments, NVMeOF SoC (502) comprises a SoC device comprising one or more processing cores, cache memory, co-processors, and other peripherals such as an Ethernet interface and a PCIe controller. NVMeOF SoC (502) may additionally include an SSD controller and NAND flash. In one embodiment, the NAND flash stores any operating system code for managing the operation of the NVMeOF SoC (502).

NVMeOF storage device (500) additionally includes optional expandable DRAM modules (504A-504B). In one embodiment, DRAM modules (504A-504B) provide temporary/volatile storage for processing undertaken by the NVMeOF SoC (502). In some embodiments, NVMeOF SoC (502) comprises a COTS SoC device. In other embodiments, the NVMeOF SoC (502) may comprise an ASIC or FPGA depending on deployment strategies. In some embodiments, DRAM modules (504A, 504B) may be discarded and only the cache memory on the NVMeOF SoC (502) may be utilized for temporary storage. In this embodiment, the NVMeOF SoC (502) may optionally use one of the SSD devices (508A-508E) as a paging device providing virtual memory if needed.

In the illustrated embodiment, NVMeOF SoC (502) is connected to two physical Ethernet interfaces (506A, 506B) via an Ethernet controller located in the NVMeOF SoC (502). NVMeOF SoC (502) is additionally connected to multiple SSDs (508A-508E) via a PCIe bus and a PCIe controller included within NVMeOF SoC (502) connecting the NVMeOF SoC (502) to the SSDs (508A-508E) via a PCIe bus. In one embodiment, NVMeOF SoC (502) converts NVMe protocol requests (and frames) received via the Ethernet interfaces (506A-506B) to PCIe commands and requests sent to SSDs (508A-508D) via a PCIe bus.

In one embodiment, SSDs (508A-508D) may comprise any COTS SSD storage medium. In one embodiment, the NVMeOF storage device (500) may include a number of SSD devices (508A-508D) that is a factor of four. In this embodiment, a single, 4-lane PCIe 3.0 bus may be utilized between NVM SoC (502) and four SSD devices. In this embodiment, the read throughput of a given SSD device may be capped at 3 GB/s. Thus, a 4-lane PCIe bus would provide 12 GB/s throughput to the four SSD devices. In this example, only one 100 GbE interface would be necessary as the interface supports a data transfer rate of 12.5 GB/s (100 Gbit/s).

As a second example, the NVMeOF storage device (500) may include eight SSD devices. In this case, two 4-lane PCIe 3.0 busses would be needed and the total throughput for the SSDs would be 24 GB/s. In this example, two 100 GbE interfaces would be necessary as the combined interfaces would support a 25 GB/s transfer rate.

As can be seen, the number of Ethernet interfaces, PCI busses, and SSDs are linearly related. Specifically, the number of Ethernet interfaces required E satisfies the equation E=ceil(S/4), where S is the number of SSDs and ceil is a ceiling function. In order to optimize the efficiency of the device, the number of SSDs should be chosen as a multiple of four in order to maximize the usage of the PCIe bus(es) and the Ethernet interface(s).

As illustrated and discussed, the NVMeOF storage device (500) differs from a convention storage node as depicted in FIG. 2B in multiple ways. First, by using NVMeOF SoC (502), the NVMeOF storage device (500) does not require a separate SSD boot drive as the NVMeOF SoC (502) includes all operating system code to route NVMe request from the Ethernet interfaces (506A, 506B) to the SSDs (508A-508E). The NVMeOF storage device (500) additionally includes multiple Ethernet interfaces (506A, 506B) determined as a function of the number of SSDs (508A-508E). This architecture allows for maximum throughput of data to the SSDs (508A-508E) without the bottleneck caused by a standard microprocessor.

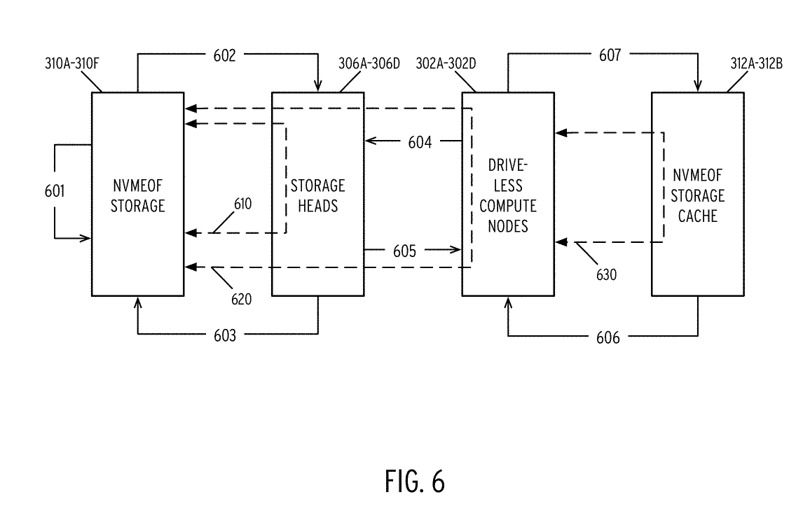

FIG. 6 is a traffic diagram illustrating traffic routes through a three-stage disaggregation network architecture according to some embodiments of the disclosure.

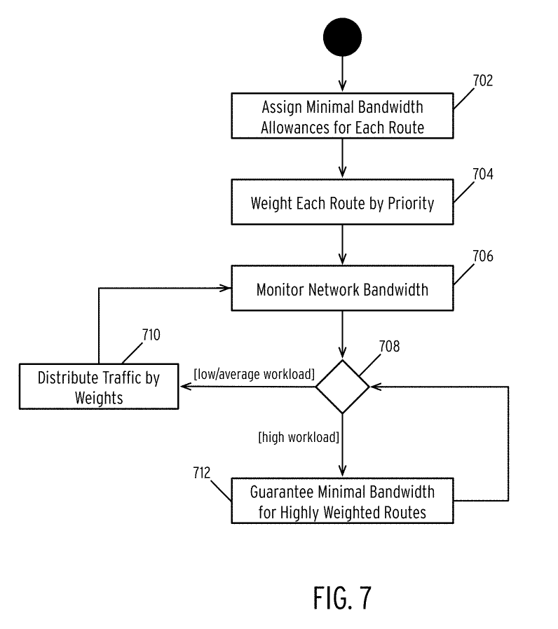

Using the three-stage architecture discussed in the description of FIG. 3, the number of traffic routes within the system necessarily increases. FIG. 6 illustrates the routes of traffic during operation of the system. As will be discussed in the description of FIG. 7, these routes may be used to prioritize traffic during operations. The diagram in FIG. 6 includes NVMeOF storage (310A-310F), storage heads (306A-306D), drive-less compute nodes (302A-302D), and NVMeOF storage cache (312A-312B). These devices correspond to the identically numbered items in FIG. 3, the description of which is incorporated by reference herein.

Route (601) is equivalent to a first path comprising direct data transfer among NVMeOF storage devices in a storage cluster such as the direct copy, update, synchronization through the remote direct memory access (RDMA).

A second path (620) corresponds to communications between NVMeOF storage devices (310A-310F) and storage heads (306A-306D). This path may comprise two separate sub-paths. A first sub-path (610) comprises routes (602) and (603). This sub-path may be used for management of the NVMeOF storage devices (310A-310F) via storage heads (306A-306D) as discussed previously. A second sub-path (620) comprises routes (602), (603), (604), and (605). This second sub-path comprises data read and writes between drive-less compute nodes (302A-302D) and NVMeOF storage (310A-310F), as discussed previously.

A third path (630) comprises routes (607) and (608). This third path comprises cache reads and writes between drive-less compute nodes (302A-302D) and NVMeOF storage cache (312A-312B) as discussed previously.

Thus, three paths (601, 610, 620, and 630) using routes (601-607) are illustrated. These three routes may have differing priorities in order to manage and control traffic throughout the system for compute traffic and storage traffic. As illustrated compute traffic (path 620 and 630) and storage traffic (paths 601 and 610) co-exist within the network. As discussed above, while compute fabric (paths) and storage fabric (paths) may be implemented via independent fabrics, the fabrics may also be combined into a single fabric. For example, the physical fabric connections for both fabrics could be on the same top-of-rack switch if the storage head and NVMeOF storage devices are in the same physical rack. In this embodiment, an increase in storage traffic would degrade the system's ability to handle compute traffic. Specifically, when the workload on the system is heavy and there are multiple, intensive back-end processing jobs (backfill, rebalance, recovery, etc.), a switch providing the fabric could be overloaded. As a result, the quality of service (QoS) may be affected when a front-end query to a compute node cannot be fulfilled within a defined response period. This long latency additionally affects the latency statistics for any service level agreements (SLAs) implemented by the system.

As described above, each device in the system is assigned an independent IP address. Due to this assignment, the system may tag packets (which include an origin and destination) with a priority level to quantize the importance of the packet allowing the switch to prioritize shared fabric traffic. In general, back-end traffic (paths 601 and 610) are assigned a lower priority and compute traffic (paths 620 and 630) are assigned a higher priority such that lower priority traffic yields to higher priority traffic. Using this scheme, reasonable bandwidth is guaranteed to avoid the back-end processing jobs temporarily utilizing a majority of the available bandwidth which causes the I/O hangs of the front-end applications executing on the compute nodes. Methods for performing this prioritization are discussed below.

FIG. 7 is a flow diagram illustrating a method for ensuring quality of service in a three-stage disaggregation network architecture according to some embodiments of the disclosure.

In step 702, the method assigns a minimal bandwidth allowance for each traffic route.

In one embodiment, the traffic routes assigned in step 702 correspond to the routes discussed in the description of FIG. 6. That is, the traffic routes comprise routes between devices in the network or, in the case of route 601, a self-referential route. In some embodiments, the routes used in the method illustrated in FIG. 7 may comprise various paths comprising multiple routes.

In one embodiment, the minimal bandwidth allowance comprises the minimum bandwidth for a given route to satisfy an SLA. For example, routes 604 and 605 comprising compute traffic routes may be assigned a higher bandwidth allowance and maintenance route 601. Similarly, cache routes 606 and 607 may be assigned a lower bandwidth allowance than routes 604 and 605 due to the temporal nature of the cache routes.

In one embodiment, each minimal bandwidth allowance may be denoted as Bᵢ where i corresponds to a given route. Likewise, the total bandwidth may be denoted as Bₜₒₜₐₗ. In this scenario, Bₜₒₜₐₗ represents the total available bandwidth for the entire fabric implementing the traffic routes. In one embodiment, values for Bᵢ may be set such that

$$B > {\sum }_{i = 0}^{n} {B}_{i}$$

where n is the total number of routes in the network.

In step 704, the method weights each route based on a route priority.

As described in the description of FIG. 6, each route may have a priority based on the type of traffic handled by the route and the origin and destination of the route. For example, route 602 originates at an NVMeOF storage device and terminates at a storage head. Thus, this path corresponds to a back-end route and may be assigned a lower priority. Conversely, routes 604 and 605 include a compute node as the origin and destination, respectively and thus correspond to a higher priority route since the route handles compute traffic. In some embodiments, routes may share the same priority level while in other embodiments each route may have a discrete priority level.

The following example illustrates an exemplary weighting, where a higher numeric value for the weight indicates a higher weighted route:

TABLE 1

| Route | Origin | Destination | Weight |
|---|---|---|---|
| 601 | NVMeOF Storage | NVMeOF Storage | 1 |
| 602 | NVMeOF Storage | Storage Head | 2 |
| 603 | Storage Head | NVMeOF Storage | 2 |
| 604 | Compute Node | Storage Head | 4 |
| 605 | Storage Head | Compute Node | 4 |
| 606 | Compute Node | NVMeOF Storage Cache | 3 |
| 607 | NVMeOF Storage Cache | Compute Node | 3 |

If priorities are not overlapping, an alternative mapping may be used:

TABLE 2

| Route | Origin | Destination | Weight |
|---|---|---|---|
| 601 | NVMeOF Storage | NVMeOF Storage | 1 |
| 602 | NVMeOF Storage | Storage Head | 2 |
| 603 | Storage Head | NVMeOF Storage | 3 |
| 604 | Compute Node | Storage Head | 6 |
| 605 | Storage Head | Compute Node | 7 |
| 606 | Compute Node | NVMeOF Storage Cache | 4 |
| 607 | NVMeOF Storage Cache | Compute Node | 5 |

Here, previously overlapping priorities may be assigned to discrete priority levels. In one embodiment, the decision to prioritize two routes in opposite directions between two devices may be made based on the origin and destination. For example, route 605 may be prioritized above route 604 due to the data being transmitted to a compute node versus being written by a compute node. The specific weighting of each route may be defined based on observed traffic of the network.

In step 706, the method monitors the bandwidth utilized by the network.

In one embodiment, a fabric switch (or group of switches) may monitor the amount and type of traffic transmitted across the fabric to determine, at any instance, how much bandwidth is being occupied by network traffic. In some embodiments, the switches may further predict future traffic levels based on observed traffic patterns (e.g., using a machine learning algorithm or similar technique).

In step 708, the method determines the current bandwidth utilization of the fabric.

In step 710, if the bandwidth is currently experiencing a low or average workload, the method distributes traffic according to the weights.

In step 710, the network is not utilizing the entire bandwidth available, the remaining bandwidth may be allocated based on the weights of each routes. In one embodiment, the method inspects incoming packets and extracts the origin and destination of the packets to identify the route associated with the packet (e.g., using Tables 1 or 2). After identifying the route, the method may update a QoS indicator of the packet (e.g., an IEEE 802.1p field) to prioritize each incoming packet. Table 3, below, illustrates an exemplary mapping of route weights to 802.1p priority codes.

TABLE 3

| Route | Origin | Destination | Weight | Priority Code Point |
|---|---|---|---|---|
| 601 | NVMeOF | NVMeOF Storage | 1 | 1 (Background) |
| | Storage | | | |
| 602 | NVMeOF | Storage Head | 2 | 2 (Spare) |
| | Storage | | | |
| 603 | Storage Head | NVMeOF Storage | 3 | 0 (Best Effort) |
| 604 | Compute Node | Storage Head | 6 | 5 (Video) |
| 605 | Storage Head | Compute Node | 7 | 6 (Voice) |
| 606 | Compute Node | NVMeOF Storage | 4 | 3 (Excellent Effort) |
| | | Cache | | |
| 607 | NVMeOF | Compute Node | 5 | 4 (Controlled Load) |
| | Storage Cache | | | |

While described in terms of 802.1p, any prioritization scheme supported by the underlying fabric protocols.

As part of step 710, the method continues to route packets to the identified destinations subject to the QoS tagging of the packets in step 710.

In step 712, the method guarantees minimal bandwidth for highly weighted routes. In the illustrated embodiment, step 712 is executed after the method determines that the network is experiencing a high workload volume.

In on embodiment, step 712 may be performed similarly to step 710, however the specific QoS tags selected will vary based on network conditions. For example, the method may prioritize compute traffic packets while reducing the QoS for all other packets. For example, the method may prioritize future traffic as follows:

TABLE 4

| Route | Origin | Destination | Weight | Priority Code Point |
|---|---|---|---|---|
| 601 | NVMeOF | NVMeOF Storage | 1 | 1 (Background) |
| | Storage | | | |
| 602 | NVMeOF | Storage Head | 2 | 1 (Background) |
| | Storage | | | |
| 603 | Storage Head | NVMeOF Storage | 3 | 1 (Background) |
| 604 | Compute Node | Storage Head | 6 | 5 (Video) |
| 605 | Storage Head | Compute Node | 7 | 6 (Voice) |
| 606 | Compute Node | NVMeOF Storage | 4 | 2 (Spare) |
| | | Cache | | |
| 607 | NVMeOF | Compute Node | 5 | 2 (Spare) |
| | Storage Cache | | | |

In this example, the back-end traffic (routes 601-603) is assigned to the lowest priority level while the compute traffic accessing the storage head is assigned to the highest relative priority level. Similarly, compute traffic to cache is assigned to a second highest priority level.

After reassigning the priority levels after detecting a high workload, the method continues to tag incoming packets. Additionally, the method continues to monitor the workload in step 708. Once the method detects that workload has returned to a low or average workload, the method re-prioritizes the routes based on weights in step 710.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A system comprising:
a plurality of compute nodes configured to receive requests for processing by one or more processing units of the compute nodes;
a plurality of storage heads connected to the compute nodes via a compute fabric, the storage heads configured to manage access to non-volatile data stored by the system; and
a plurality of storage devices connected to the storage heads via a storage fabric, each of storage devices configured to access data stored on a plurality of devices in response to requests issued by the storage heads.

2. The system of claim 1, further comprising a plurality of storage cache devices communicatively coupled to the compute nodes via the compute fabric.

3. The system of claim 1, a compute node further comprising a network interface card (NIC) communicatively coupled to the processing units, the NIC comprising a NAND Flash device storing an operating system executed by the processing units.

4. The system of claim 3, a storage head comprising:
a second plurality of processing units; and
a second NIC communicatively coupled to the second plurality of processing units, the second NIC comprising a second NAND Flash device storing a second operating system executed by the plurality of second processing units.

5. The system of claim 1, a storage device comprising:
a processing element;
a plurality of storage devices connected to the processing element via a PCIe bus; and
one or more Ethernet interfaces connected to the processing element, a number of the Ethernet interface comprising a number linearly proportional to a number of the storage devices.

6. The system of claim 5, the processing element comprising a system-on-a-chip (SoC) device, the SoC device including a PCIe controller.

7. The system of claim 6, the SoC device configured to convert NVM Express packets received via the one or more Ethernet interfaces to one or more PCIe packets.

8. The system of claim 1, the plurality of compute nodes, the plurality of storage heads, and the plurality of storage devices each being assigned a unique Internet Protocol (IP) address.

9. The system of claim 1, the storage fabric and the compute fabric comprising a single physical fabric.

10. The system of claim 9, the single physical fabric including at least one switch, the at least one switch configured to prioritize network traffic based on an origin and destination included in a packet.

11. The system of claim 10, the switch further configured to prioritize packets based on a detected network bandwidth condition and a weighting assigned to routes between each of the compute nodes, the storage heads, and the storage devices.

12. The system of claim 9, the single physical fabric comprising an Ethernet or InfiniBand fabric.

13. The system of claim 1, the storage heads coordinating management operations of the storage devices.

14. The system of claim 1, the storage devices performing remote direct memory access (RDMA) operations between individual storage devices.

15. The system of claim 1, each of the compute nodes being installed in a single server blade.

16. A device comprising:
a plurality of processing units; and
a network interface card (NIC) communicatively coupled to the processing units, the NIC comprising a NAND Flash device, the NAND Flash device storing an operating system executed by the processing units.

17. A method comprising:
assigning, by a network switch, a minimal bandwidth allowance for each of a plurality of traffic routes in a disaggregated network, the disaggregated network comprising a plurality of compute nodes, storage heads, and storage devices;
weighting, by the network switch, each traffic route based on a traffic route priority;
monitoring, by the network switch, a current bandwidth utilized by the disaggregated network;
distributing, by the network switch, future packets according to the weighting if the current bandwidth is indicative of a low or average workload; and
guaranteeing, by the network switch, minimal bandwidth for a subset of the traffic routes if the current bandwidth is indicative of a high workload, the subset of traffic routes selected based on the origin or destination of the route comprising a compute node.

18. The method of claim 17, the assigning a minimal bandwidth allowance comprising assigning a minimal bandwidth allowance for each of the traffic routes such that the sum of the minimal bandwidth allowances does not exceed a total bandwidth of the disaggregated network.

19. The method of claim 17, the weighting each traffic route comprising assigning a high priority to a traffic route having an origin or destination comprising a compute node and a low priority to a traffic route not having an origin or destination comprising a compute node.

20. The method of claim 17, the distributing future packets comprising assigning a quality of service level of the future packets.
